(19) United States
(12) Patent Application Publication
(10) Pub. No.: US 2025/0136764 A1
(43) Pub. Date: May 1, 2025

(54) PROCESS FOR PREPARING HYDROSILOXANES

(71) Applicant: Evonik Operations GmbH, Essen (DE)

(72) Inventors: Wilfried Knott, Essen (DE); Matthias Lobert, Essen (DE); Christian Havekost, Dorsten (DE)

(73) Assignee: Evonik Operations GmbH, Essen (DE)

(21) Appl. No.: 18/930,477

(22) Filed: Oct. 29, 2024

(30) Foreign Application Priority Data
Oct. 31, 2023 (EP) 23206871.8
Nov. 9, 2023 (EP) 23208762.7

(51) Int. Cl. C08G 77/08; C08G 64/00

(52) U.S. Cl. CPC C08G 77/08; C08G 64/00

(57) ABSTRACT

A process prepares hydrosiloxanes using acid-modified aluminium silicate as equilibration catalyst, where pulverulent aluminium silicate is applied, with mixing, to a siloxane mixture that consists of at least two siloxanes and at least one SiH-functional siloxane. The acid-modified aluminium silicate is prepared in situ with addition of acid, and the resulting reaction mixture is allowed to react with further mixing in the sense of an equilibration.

### CROSS-REFERENCE TO RELATED APPLICATIONS

This application is a New U.S. patent application which claims priority to European Patent Application No. 23206871.8, filed on Oct. 31, 2023, and to European Patent Application No. 23208762.7, filed on Nov. 9, 2023, the content of each of which is hereby incorporated by reference in its entirety.

### BACKGROUND OF THE INVENTION

### Field of the Invention

The present invention is in the field of siloxanes. In particular, it relates to a process for preparing hydrosiloxanes.

The use of acid-treated bleaching earths, that is to say of acid-treated aluminium silicates, as catalysts in the industrial production of silicone products is known.

### Description of Related Art

For example, U.S. Pat. No. 2,460,805 teaches the preparation and use of acid-activated bleaching earths for the condensation of SiOH group-containing organosiloxanes to form polymers of relatively high molar mass. The porous earths or loam minerals (Florida earth, Kambara earth, bentonite or other aqueous aluminium silicates) used in said document have large specific surface areas and are impregnated with a mineral acid, then dried at 100° C. or an even higher temperature and comminuted down to the desired degree of particle fineness, in order to subsequently disperse the thus obtained particles in the siloxanol to be condensed. The teaching of U.S. Pat. No. 2,460,805 speaks of simple handling and storage stability of the acid-treated aluminium silicate.

Likewise, patent document DE 957 662 C (U.S. Pat. No. 2,831,008), which is dedicated to the preparation of silicone oils, focuses in Example 4 on the use of acid-activated, neutral-washed bleaching earth in the reaction of octamethylcyclotetrasiloxane with hexamethyldisiloxane, where octamethyltrisiloxane is formed as the main product.

Aiming at silanol polydiorganosiloxanes having viscosities between 1000 and 10 000 000 centipoise, U.S. Pat. No. 3,903,047 discloses the reaction of low-viscosity, silanol group-bearing liquids with cyclic polysiloxanes, where a broad range of previously acid-activated aluminium silicates are mentioned as preferred catalysts.

DE 197 56 832 A1 discloses the use of acid-activated bleaching earths, obtained by way of the treatment of clays, which, as sheet silicates, represent the weathering product of aluminium oxide-containing rocks, as catalyst for the condensation or equilibration of hydroxyl group-, alkoxy group-, chlorine- or triorganosilyl group-containing siloxanes with siloxane cycles and hexaorganodisiloxanes, where commercially available acid-activated clay (Tonsil® or Filtrol®) is treated at temperatures of 80° C. to 170° C. with mineral acids such as hydrochloric acid, sulfuric acid or phosphoric acid and subsequently the acid-activated clays are heated to 250° C. to 1200° C. for at least 50 minutes.

Describing the redistribution of SiH bonds in the temperature range of 50° C. to 250° C., U.S. Pat. No. 3,398,177 teaches that the acidity of the aluminium silicates used in said document can be increased by washing them with solutions of aqueous strong inorganic acids such as HCl or H₂SO₄ or by selecting another acid treatment with subsequent heating of the aluminium silicate. However, in comparison with other acidic solid phases and even in comparison with a colloidal, natural kaolin (c) according to the disclosure of U.S. Pat. No. 3,398,177, the acid-washed kaolin (d) used ibid. in Example 12 proves to be only a modest catalyst (66.4% vs. 89.6% yield) in the cleavage of dimethylsilane from tetramethyldisiloxane at 109° C. over a reaction time of 23 hours (condensation reaction).

DE 44 24 115 A1 discloses a process for preparing linear, triorganosiloxy end group-comprising silicone liquids with low silanol content, where use is also made of acid-treated clay granules (Filtrol®-24).

U.S. Pat. No. 5,239,101 discloses an anhydrous process for preparing organosiloxy-endcapped polyorganosiloxanes from chlorine-endcapped polyorganosiloxanes, where acid clays obtained from halloysite, kaolinite, and bentonites composed of montmorillonites are used here as rearrangement catalyst.

In a slightly different design, U.S. Pat. No. 5,233,070 discloses the use of acid clays also as catalyst for the preparation of polyorganocyclosiloxanes starting from chlorine-endcapped polyorganosiloxanes.

Dedicated to the rearrangement of linear, chlorine- or hydroxy-endcapped polyorganosiloxanes with cyclic polyorganosiloxanes, U.S. Pat. No. 5,068,383 describes the use of acid-treated clays as rearrangement catalyst.

U.S. Pat. No. 4,895,967 describes a process for preparing cyclic poly(siloxane)s, where, at temperatures between 200° C. and 800° C. and advantageously with an applied auxiliary vacuum, cyclic organohydrosiloxanes are thermally separated from linear hydrosiloxanes by contacting with an acid clay (Filtrol®-20).

U.S. Pat. No. 4,831,174 discloses the preparation of triorganosilyl-endcapped polydiorganosiloxane liquids using acid-activated clays in an continuous process. U.S. Pat. No. 4,230,816 discloses the equilibration of (alkylthio)- or mercaptoalkyl group-bearing siloxanes in the presence of acid catalysts. In addition to a series of liquid, strong acids, use is made of Filtrol®-13 and Filtrol®-24 (Filtrol Corporation) as acid-treated clays.

GB 922,377 describes phyllo- and inosilicates for the preparation of organohydropolysiloxanes and shows that specific previously acid-activated, but also some non-acid-activated, aluminium silicates (calcium bentonite in Example 3, sodium bentonite in Example 4, atapulgite “Floridin” in Example 5, all ibid.) are suitable for the preparation of α,ω-dihydropolydimethylsiloxanes. In the case of the bleaching earths previously activated with acid, they are first washed to neutrality after acid treatment and then dried at approx. 200° C. In comparative experiments to equilibrate tetramethyldisiloxane with octamethylcyclotetrasiloxane, it was shown according to GB 922,377 that concentrated sulfuric acid as catalyst brings about only an incomplete reaction after heating for 5 hours at 50° C. Five further hours of reaction first with reflux boiling of the tetramethyldisiloxane at 71° C., then with an increase in temperature to 100° C. then resulted in an equilibrate but with a significant loss of valuable SiH function. According to GB 922,377, the use of kaolin as catalyst in an analogous experiment showed that even after heating to 150° C. no loss of hydrogen was recorded, but that the reaction also remained incomplete.

The disclosure of CN 103524743 A is dedicated to the preparation of hydrogen-containing silicone oils with terminal SiH groups by means of a polymerization reaction and describes that hydrogen-rich polysiloxane and cyclosiloxane are reacted with a terminal SiH group-bearing siloxane with addition of an organic solvent and under the action of an acid catalyst, such as an acid-activated clay, and then a two-phase substance system is produced with input of water. The acidified water phase is removed and the input of water and the removal of the acid-containing water phase are repeated 4 times. In addition to solvent, the organic phase contains a terminal SiH group-bearing hydrosiloxane oil, unreacted, hydrogen-rich polysiloxane and siloxane cycles, that is to say the siloxane matrix according to the disclosure of CN 103524743 A is definitely not an equilibrate. A laborious vacuum distillation at 0.095 MPa pressure and 180° C. is necessary in order to isolate, after removal of the volatiles, a hydrogen-containing silicone oil with terminal SiH groups.

The prior art also describes the preparation of acid-activated aluminium silicates.

For example, W. Gao, S. Zhao, H. Wu, W. Deligeer and S. Asuha in “Direct acid activation of kaolinite and its effects on the adsorption of methylene blue”, Applied Clay Science 126 (2016), 98-106 on page 99, ibid. state that the activation of a natural kaolin mineral by way of acid treatment is difficult since this material is inactive and a heat treatment at temperatures between 600° C. and 800° C. before the acid treatment is thus imperative.

Such an opinion is also supported by significantly older works from the prior art, which are concerned with processes for preparing acid-activated kaolin clay, such as U.S. Pat. No. 2,477,664, where a kaolin clay is first pelletized and then calcined at 566° C. for 2 hours. This is then followed by an acid treatment with 15% hydrochloric acid and a pressurized water treatment in an autoclave at 232° C.

To further elucidate the technical complexity involved according to the prior art, reference should be made here for example to the article by A. K. Panda, B. G. Mishra, D. K. Mishra, R. K. Singh “Effect of sulphuric acid treatment on the physico-chemical characteristics of kaolin clay” in Colloid and Surfaces A: Physicochem. Eng. Aspects 363 (2010), 98-104, in which the authors heat the natural kaolin to be activated with 10 times the amount of sulfuric acid at 110° C. for 4 hours in a reflux condenser, then quench it with ice water, filter it off, wash it multiple times with distilled water, dry it in an oven and then calcine it at 500° C. for an hour, in order to then finally convert it to a powder form using a mortar and pestle.

U.S. Pat. No. 2,470,872 teaches the preparation of acid-activated aluminium silicates (sub-bentonites) with a focus on the preparation of acid-activated montmorillonite, where the high-temperature acid treatment is followed by quenching in cold water, washing until acid- and salt-free, filtration, drying and grinding (Example 1 in said document). The teaching of this document represents one of the so-called “wet” processes.

In this connection and as a further reference for the obtaining of acid-activated aluminium silicates according to the prior art, reference should also be made to the teaching of the examined and published application DE 1 063 127, which describes a process for converting kaolin clay into technically usable, adsorption-capable contact compositions and employs a so-called “dry” process, which provides for the aluminium silicate not to be washed out after completed acid treatment, but to be directly calcined, such that the overall chemical composition of the clay is intended to remain unchanged as a result.

Acknowledging the successes achieved in siloxane chemistry to date with acid-activated aluminium silicates, the fundamental tendency of these catalysts towards modification of the skeleton during their storage in particular under non-inertized conditions has, however, proven to be disadvantageous when they are used industrially. Ageing phenomena, for example additionally promoted by normal air humidity, are capable of causing irreversible skeletal rearrangements in previously acid-treated aluminium silicate within a few days.

For example, the study by C. N. Rhodes and D. R. Brown “Autotransformation and Ageing of Acid-treated Montmorillonite Catalysts: A Solid-state ²⁷Al NMR Study” (J. Chem. Soc. Faraday Trans., 1995, 91(6), 1031-1035), which is specifically focused on the stability behaviour of acid-treated montmorillonites, shows that the disadvantage of these materials is in their inherent instability, which results in changes in their chemical and physical properties during their ageing. Combined use of elemental analysis and solid-state ²⁷Al NMR (magic-angle spinning NMR) enabled a deeper insight into the ageing processes of acid-treated montmorillonite because it is possible, not least by way of the ²⁷Al NMR, to easily distinguish between octahedrally and tetrahedrally coordinated oxo-aluminium centres. For the investigation, use was made of commercially available, acid-treated montmorillonites (Fulcat 22A and a low-iron Texas montmorillonite from Laporte) that had each been treated at 95° C. in the form of a 1% suspension with 30 vol % sulfuric acid with rapid stirring, subsequently washed with deionized water and dried at 60° C. C. N. Rhodes and D. R. Brown make it clear in the study in question that, during the acid treatment of a montmorillonite clay, an ion exchange takes place, in which Al³⁺ and other metal cations are replaced by protons (H⁺). As a result thereof, the clay mineral that is built up in layers gradually delaminates and its capability to be a cation exchanger decreases. The main ageing process is considered to be the autotransformation of the H⁺-exchanged clay to an Al³⁺-exchanged (and to a certain extent also Mg²⁺- and Fe³⁺-exchanged) form of the clay, in which the H⁺ ions migrate into the solid lattice and in turn metal ions migrate to the exchange sites. This autotransformation can occur even under the aggressive conditions of an industrially performed acid treatment in particular at elevated temperature over a relatively long period of time and is promoted, as the authors C. N. Rhodes and D. R. convincingly demonstrate, by (high) humidity during the storage of the acid-activated montmorillonite, with the result that a loss of both ion exchange capacity and acidity is expected.

In particular, it is this unforeseeable loss of acidity that can cause the use of acid-treated aluminium silicates, preferably acid-treated montmorillonites, to become a great uncertainty in the industrial production (equilibration) in particular of demanding hydrogen-bearing siloxanes.

Depending on the desired target structure of the respective hydrogen-bearing siloxane, the acidity effective in the equilibration system is of key importance.

For example, the SiH function-maintaining equilibration of both dimethylhydrosiloxy group-bearing and methylhydrosiloxy unit-bearing siloxanes in the equilibration matrix represents the greatest challenge to date, and so superacids such as perfluoroalkanesulfonic acids, particularly trifluoromethanesulfonic acid and perfluorobutanesulfonic acid, are still the preferred homogeneous catalysts for the industrial equilibration of these particular hydrosiloxanes.

The difficulty in the equilibration of these dimethylhydrosiloxy group-bearing, unbranched, but also methylhydrosiloxy group- and dimethylsiloxy group-comprising hydrosiloxanes, lies in the achievement of a very substantially statistical uniform distribution of SiH functions along the oligomer chain, without too many of the sensitive dimethylhydrosiloxy groups thus being lost due to dehydrogenative processes or dimethylsilane cleavage.

In contrast to perfluorinated superacids, the effective acidity of acid-treated aluminium silicates and also for example sulfonic acid ion exchange resins in SiH group-containing siloxane matrices is significantly lower, and so it is very important when using these catalysts to find the suitable reaction parameters for the respective equilibration system.

The required acidity is specifically guided here by the equilibration task to be achieved, that is to say by the structure of the desired hydrosiloxane. The synthesis of α,ω-dihydropolydimethylsiloxanes places the lowest demands on the acidity exerted by the catalyst, that is to say its ability to provide protons.

If for example a mixture consisting of octamethylcyclotetrasiloxane and tetramethyldisiloxane is converted under acid catalysis to α,ω-dihydropolydimethylsiloxanes, then theoretically only one proton is needed for the opening of an octamethylcyclotetrasiloxane molecule initiated by protonation of the oxygen atom in an SiOSi bond present therein.

Only one proton is likewise theoretically needed for example for the opening of the SiOSi bond present in the tetramethyldisiloxane molecule. The adjustment of the oligomer chain distribution additionally requires comparatively low protic activity.

However, the conditions are completely different for example in the case of those copolymeric siloxanes that contain methylhydrosiloxy units (D^{H} units) and dimethylsiloxy units (D units) in addition to trimethylsilyl groups (M units) and that are prepared for example from poly(methylhydro)siloxane and octamethylcyclotetrasiloxane and hexamethyldisiloxane under acid catalysis. Theoretically only one proton is needed for the opening of an octamethylcyclotetrasiloxane molecule after protonation of the oxygen atom in one of the four SiOSi bonds present therein. Likewise, only one proton is theoretically required for the initiation of the opening of the SiOSi bond present in the hexamethyldisiloxane molecule. The molecular decomposition of the poly(methylhydro)siloxane also theoretically needs in each case only one proton per siloxanyl bond (SiOSi bond). In order however to achieve a statistical distribution of the methylhydrosiloxy units along the oligomer chains of the for example desired poly(methylhydrosiloxane)-polydimethylsiloxane copolymer particularly in the time windows customary for industrial silicone production, a far greater number of protons are needed per volume of reaction mass, since only a virtually simultaneous breaking and relinking of multiple SiOSi bonds produces a copolymer that does not have any accumulation(s) of methylhydrosiloxy units (=D^{H} units) within the siloxane oligomer chains.

This purely statistical-theoretical consideration of the acidity needed for the equilibration of such siloxane copolymers is experimentally supported by the publication by G. Sauvet, M. Moreau. G. Hélary, E. Daudet, P. Cancouet, “Functional polysiloxanes. I. Microstructure of poly(hydrogenmethylsiloxane-co-dimethylsiloxane) s obtained by cationic copolymerization” in J. Polymer Science, Part A: Polymer Chemistry Vol. 38, 826-36 (2000), in which the authors (on page 833, ibid.) come to the clear conclusion that a siloxane bond (SiOSi) between two D^{H} units is less reactive than that between two D units, which directly influences the partial reactions, such as backbiting, crosslinking and acidolysis, that are involved in the acidic equilibration.

The accumulation of methylhydrosiloxy groups should preferably be avoided as far as possible, as the subsequent usefulness of the hydrosiloxane equilibrates in hydrosilylation reactions, particularly in those in which polyether mixtures are used to obtain polyethersiloxanes for demanding surfactant applications, for example as stabilizer in polyurethane foams, is directly linked to the structural feature of copolymers having polyether-bearing Si atoms that are distributed over the oligomer chains as statistically as possible, that is to say are isolated from one another as much as possible, because they are separated from one another by D units.

G. Sauvet et al. (page 835, right-hand column, ibid.), in their previously mentioned publication (see above; in J. Polymer Science, Part A: Polymer Chemistry Vol. 38, 826-36 (2000)), reach the conclusion that the knowledge of the distribution of D and D^{H} units in the chain is the key to understanding the properties of the (SiH) copolymers per se and even more so the properties of the functionalized derivatives derived therefrom. The authors point to the direct influence of the distribution of D and D^{H} units in the chain on the reaction speed in the case of hydrosilylation reactions.

In this context, P. Cancouet, S. Pernin, G. Hélary, G. Sauvet, in their article “Functional polysiloxanes. II. Neighboring effect in the hydrosilylation of poly(hydrogenmethylsiloxane-co-dimethylsiloxane) s by allylglycidylether” in J. Polymer Science, Part A: Polymer Chemistry, Vol. 38, 837-45 (2000), investigated the neighbouring group effect in the hydrosilylating addition of allylglycidylether onto poly(methylhydrosiloxane)-polydimethylsiloxane copolymers and demonstrated that the presence of methylhydrosiloxy diades (D^{H}-D^{H}) leads to an accelerated hydrosilylation, while isolated, that is to say D unit-surrounded, D^{H} units (D-D^{H}-D) exhibit slower reaction kinetics.

Against the background of this finding, it is apparent to those skilled in the art that the microstructure of the hydrosiloxanes, particularly in the case of the addition of polyether mixtures with their range of individual reactivities, has a significant influence on the subsequent target structure of the polyethersiloxane copolymer.

Methods for determining the molecular fine structure in hydrosiloxanes are known. For example, G. Sauvet et al., in the above-mentioned publication (see above; J. Polymer Science, Part A: Polymer Chemistry Vol. 38, 826-36 (2000)), in particular use high-resolution ²⁹Si NMR spectroscopy to detect diads, triads, pentads, etc., that is to say accumulations of methylhydrosiloxy groups, in a poly(methylhydrosiloxane)-polydimethylsiloxane copolymer.

To date, however, NMR technology as an in-process analysis method, specifically as a real-time method, has not gained a place in the industrial production of polyorganohydrosiloxanes, this being due to factors including the costs for the equipment to be installed but in particular also the fundamental problem of accommodating sources of extremely strong electromagnetic radiation, such as NMR magnets and measurement heads, in an operationally safe manner in explosion-protected production plants.

The teaching of WO2022/132446 A1 seeks to address the question of an in-process analysis by using, specifically supported by examples therein, vibrational spectroscopic methods such as infrared spectroscopy and Raman spectroscopy to determine structures directly linked to one another (D^{H}-D^{H}) and structures separated from one another (D-D^{H}-D) in the acid-catalyzed equilibration of siloxanes acting as D source and siloxanes acting as D^{H} source in order to assess the degree of distribution achieved. Focussing on the curing rate in siloxane elastomers, a direct relationship is seen between the vibrationally spectroscopically determined concentration of decoupled, that is to say statistically distributed, SiH groups and the curing kinetics when using the respective SiH copolymer. For example (ibid. page 18, Table 3), an SiH copolymer from Batch 1, after 3 hours of equilibration time and a SiH IR intensity of 2.08 introduced into an elastomer system, needs 144.3 seconds for through-curing, whereas an SiH copolymer originating from Batch 7, after 16 hours of equilibration time and with a measured SiH IR intensity of 3.32, already leads to curing of the elastomer system after only 61.4 seconds.

Aiming in particular at a very wide variety of curing systems (condensation- and/or hydrosilylation-curable products) as target products, the method presented in WO2022/132446 A1 is intended to help to minimize batch times and simultaneously to achieve higher statistical uniformity of the equilibrated SiH copolymer.

### SUMMARY OF THE INVENTION

The present invention is concerned, particularly against the background mentioned above, with the preparation of hydrosiloxanes, specifically preferably those that, with very substantially statistical uniform distribution of SiH functionality, have pendant SiH in the form of methylhydrosiloxy groups and dimethylhydrosiloxy groups, as well as dimethylsiloxy groups and preferably also trimethylsilyl groups. In particular in view of the above-described disadvantages of a lack of ageing resistance of acid-activated aluminium silicates, it was the object of the present invention to provide a further process for preparing hydrosiloxanes using a equilibration catalyst, preferably with a view to the equilibration of dimethylhydrosiloxy group-bearing, unbranched, but also methylhydrosiloxy group- and dimethylsiloxy group-comprising hydrosiloxanes, preferably having the average structural formula according to Formula (1):

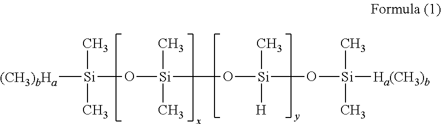

in order to achieve preferably a very substantially statistical uniform distribution of SiH functions along the oligomer chain, preferably without too many of the sensitive dimethylhydrosiloxy groups thus being lost due to dehydrogenative processes or dimethylsilane cleavage,
where in Formula (1):
0≤x≤200, preferably 20≤x≤160, particularly preferably 30≤x≤80,
1≤y≤30, preferably 2≤y≤26, particularly preferably 2≤y≤10,
0.4≤a≤1.0, preferably 0.6≤a≤0.95,
0≤b≤0.6, preferably 0.05≤b≤0.4,
a+b=1,
particularly preferably x+y+2≥13.

Astonishingly, the inventors of this present invention have found that it is possible to carry out the equilibration of hydrosiloxanes, preferably of the structure type mentioned above, in a reliably reproducible manner if pulverulent aluminium silicate is applied to a corresponding siloxane mixture, in order, with addition of acid, to prepare in situ acid-modified aluminium silicate, and then the reaction mixture is allowed to react.

### DETAILED DESCRIPTION OF THE INVENTION

The subject of the invention, which achieves the object mentioned above, is a process for, preferably water- and solvent-free, preparation of hydrosiloxanes using acid-modified aluminium silicate as equilibration catalyst, where pulverulent aluminium silicate, preferably pulverulent kaolin, is applied, with mixing, to a siloxane mixture that consists of at least two siloxanes and contains at least one SiH-functional siloxane and the acid-modified aluminium silicate is prepared in situ with addition of acid, preferably mineral acid, particularly concentrated sulfuric acid, with the result that a reaction mixture is formed and then the reaction mixture is allowed to react with further mixing, and preferably heating, in the sense of an equilibration, preferably until the equilibrium of the desired hydrosiloxane has been achieved.

Hydrosiloxanes are SiH-functional siloxanes, that is to say siloxanes which bear at least one SiH function, preferably at least two SiH functions.

It is preferred according to the invention for the siloxane mixture to consist of at least two different siloxanes that together have methylhydrosiloxy groups, dimethylhydrosiloxy groups and dimethylsiloxy groups, and preferably trimethylsilyl groups, where siloxanes usable with particular preference are for example poly(methylhydro)siloxane, tetramethylcyclotetrasiloxane, hexamethyldisiloxane, decamethylcyclopentasiloxane (D₅), octamethylcyclotetrasiloxane, tetramethyldisiloxane and/or α,ω-dihydropolydimethylsiloxane.

The solution according to the invention is completely surprising since previous works from the prior art that focus on the use of acid-activated aluminium silicates for equilibration of hydrosiloxanes describe, in contrast to the present invention, a procedure that provides for an already previously acid-activated aluminium silicate to be applied to the siloxane matrix provided for equilibration, where this already previously acid-activated aluminium silicate after its acid treatment has generally been washed to neutrality and/or also dried and/or calcined and/or comminuted and/or formulated.

It is even more astounding here to those skilled in the art that the in-situ acid modification according to the invention effected in the siloxane matrix, preferably under very moderate conditions, of the pulverulent aluminium silicate used can bring about such a high level of equilibration activity that it can make it possible to realize, even after a short reaction time, a very substantially statistical uniform distribution of SiH functions along the oligomer chain of the hydrosiloxane, without, preferably with a view to dimethylhydrosiloxy group-, methylhydrosiloxy group- and dimethylsiloxy group-comprising hydrosiloxanes, too many of the sensitive dimethylhydrosiloxy groups thus being lost due to dehydrogenative processes or else by dimethylsilane cleavage.

In the context of the present invention, what was not foreseeable in the light of the above-mentioned works from the prior art for preparing acid-activated aluminium silicates was particularly also the ease and the speed with which the pulverulent aluminium silicate, preferably pulverulent kaolin, introduced into the siloxane matrix provided for equilibration acquires its activity as equilibration catalyst under the action of acid, preferably mineral acid, particularly preferably concentrated sulfuric acid.

This present invention or the process according to the invention for preparing hydrosiloxanes with its acid modification of the aluminium silicate that is to be performed only in the siloxane matrix, that is to say in the siloxane mixture that consists of at least two siloxanes and contains at least one SiH-functional siloxane, advantageously not only enables a constantly consistently high equilibration activity of the catalyst in the production of hydrosiloxanes, but also has a positive effect from the aspect of a potential heath hazard in the charging or application of the pulverulent aluminium silicate for example to an industrial equilibration reactor. The required respiratory and skin protection for production staff is made much simpler when handling a pulverulent aluminium silicate that has not already been acid-modified. In the case of the particularly preferred pulverulent kaolin, it should also be noted in this context that kaolin was approved in the food industry up until 31 Jan. 2014 in the functional classes “carrier substances, release agents and emulsifiers” under the European approval number E 559.

The waiving of complex process steps, such as acid washing, neutral washing, drying or even calcining or sintering, that is made possible by the present invention makes the process according to the invention advantageous from the aspect of resource conservation. Energy- and resource-consuming process steps can therefore be avoided.

It is particularly preferred according to the invention to carry out the equilibration for the preparation of hydrosiloxanes in substance, that is to say to carry out the equilibration according to the invention preferably water- and solvent-free, i.e. preferably without the use of solvents, in particular without the use of organic solvents and preferably without addition of water, it however being possible for there to be present small amounts of water that originate from the acid to be used according to the invention and/or from the pulverulent aluminium silicate to be used according to the invention and that may in total be ≤5 percent by mass, preferably ≤4 percent by mass, based on the total amount of these two feedstocks.

Pulverulent aluminium silicate is used according to the invention. Pulverulent aluminium silicate is known to those skilled in the art. Pulverulent aluminium silicates usable with preference according to the invention preferably have particle sizes of less than 250 micrometres, preferably less than 100 micrometres, particularly preferably less than 80 micrometres. The particle size may be determined using the known methods of particle size determination, preferably using the known methods of laser diffraction, preferably assuming spherical particle geometry.

A pulverulent aluminium silicate usable with very particular preference according to the invention is pulverulent kaolin, preferably the naturally occurring pulverulent kaolin (CAS 1332-58-7) also called china clay.

Pulverulent kaolin is known per se to those skilled in the art. This preferably encompasses all those pulverulent clay minerals that, in the unfired state, contain kaolinite, halloysite, dickite, nacrite and/or anauxite as main clay minerals, with kaolinite being particularly preferred and being the particularly preferred main constituent of kaolin. Kaolinite can preferably be described by the following, known idealized formula: Al₂O₃·2SiO₂·2H₂O.

Pulverulent aluminium silicate, preferably pulverulent kaolin, is commercially available. For example, a corresponding pulverulent kaolin is commercially available under the trade name Speswhite™ from IMERYS Minerals Ltd., United Kingdom.

It is preferred according to the invention to use pulverulent aluminium silicate, preferably pulverulent kaolin, in a total amount of 0.3% by weight to 1.5% by weight, further preferably in a total amount of 0.5% by weight to 1.4% by weight and particularly preferably in a total amount of 0.75% to 1.35% by weight, based on the total amount of the siloxane mixture.

Acid, preferably mineral acid, particularly preferably concentrated sulfuric acid, is used according to the invention preferably in a total amount of 30 to 2500 ppm by weight, particularly preferably in a total amount of 100 to 1500 ppm by weight, based on the total amount of the siloxane mixture (ppm by weight=weight fraction in ppm (ppm=parts per million)).

Concentrated sulfuric acid is known to those skilled in the art. It preferably has a sulfuric acid content of at least 96 percent by weight, particularly preferably of at least 98 percent by weight.

As already explained, pulverulent aluminium silicate is applied, with mixing, to the siloxane mixture and acid-modified aluminium silicate is prepared in situ with addition of acid, after which the reaction mixture is allowed to react with further mixing, and preferably heating, in the sense of an equilibration.

It is preferred according to the invention to carry out the equilibration in the temperature range of 25° C. to 95° C., particularly preferably in the temperature range of 40° C. to 80° C. Said equilibration is carried out according to the invention preferably within a period of 4 to 12 hours, particularly preferably within a period of 6 to 9 hours.

The reaction mixture is preferably neutralized at the end of the equilibration, preferably with sodium hydrogencarbonate, preferably in amounts between 0.25% by weight and 1.0% by weight, based on the amount of the total siloxane mixture, and preferably with addition of water, preferably between 100 ppm by weight to 600 ppm by weight, based on the amount of the overall siloxane mixture, preferably over a period of 1 to 6 hours.

It is preferred according to the invention to separate the neutralized reaction mixture preferably after addition of a filter aid, from the solids, preferably by filtration, and to isolate the equilibrated hydrosiloxane.

Filter aids usable with preference are chemically inert substances that can support the filtration process solely due to physical-mechanical action; preferably, treated or untreated cellulose, silica gel, diatomaceous earth and/or perlite may be used.

It is preferred according to the invention if the resulting, equilibrated hydrosiloxane conforms to the following average structural formula (Formula 1)

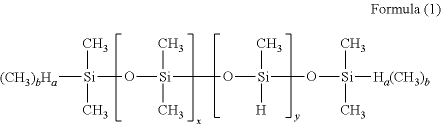

where:
0≤x≤200, preferably 20≤x≤160, particularly preferably 30≤x≤80,
1≤y≤30, preferably 2≤y≤26, particularly preferably 2≤y≤10,
0.4≤a≤1.0, preferably 0.6≤a≤0.95,
0≤b≤0.6, preferably 0.05≤b≤0.4,
a+b=1,
particularly preferably x+y+2≥13.

A further subject of the invention is a hydrosiloxane preparable, preferably prepared, by the process according to the invention.

A further subject of the invention is the use of the hydrosiloxane preparable according to the invention as coreactant in a hydrosilylation reaction for the preparation of hydrosilylation products, where the hydrosilylation reaction is preferably effected in the presence of a noble metal catalyst and at least one unsaturated organic compound, preferably terminally unsaturated organic compound, preferably terminally unsaturated alkene compounds, which may optionally also bear further substituents; particularly preferred unsaturated organic compounds are terminally unsaturated polyethers, allyl glycidyl ether, glycerol monoallyl ether, allyl glycol, allyloxyethanol, allylanisole, allylphenol, eugenol, hexenol, C6-C20-alkene, undecylenic acid and/or vinylcyclohexene monooxide; even further preferred are terminally unsaturated polyethers, allyl glycol, tetradecene, hexadecene, octadecene and/or methyl undecylenate, where use is very particularly preferably made of terminally unsaturated polyethers, such as allyl- and/or methallyl-functional polyethers, and use is especially preferably made of terminally unsaturated allyl polyethers.

A further subject of the invention is the use of hydrosilylation products preparable according to the invention
(a) as surfactant, as dispersing additive, defoamer, wetting aid, hydrophobizing agent and/or crosslinking additive, preferably for use in pastes, paints, varnishes, overcoats, coatings and/or coating agents,
(b) in cleaning and/or care formulations suitable for cleaning and/or care of hard surfaces and/or suitable for cleaning, treatment and/or aftertreatment of textiles, and in cosmetic products,
(c) as foam stabilizers or foam additives for polyurethane foams or
(d) as adjuvants for improving the effect of plant protection active ingredients and/or as carriers for plant protection active ingredients, where the plant protection active ingredients are preferably selected from microbiological plant protection active ingredients.

The example which follows serves merely to further elucidate the present invention and does not constitute any restriction of the present invention whatsoever.

### EXAMPLE

In the context of the present invention, the ²⁹Si NMR spectra were recorded with a measurement frequency of 79.49 MHz in a Bruker Avance Ill spectrometer, equipped with a 287430 sample head with a gap width of 10 mm, dissolved at 22° C. in CDCl₃ and against tetramethylsilane (TMS) as external standard [d(²⁹Si)=0.0 ppm].

The china clay used in the example according to the invention (Speswhite™, Imerys Minerals Ltd.) is a pulverulent kaolin mined in deposits in South West England.

### Example 1 (According to the Invention)

The equilibration according to the invention aimed for the following average hydrosiloxane structure:

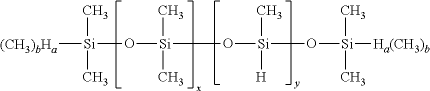

where x=36.85 and y=3.15, and a=0.92 and b=0.08.

To this end, 99.18 g of poly(methylhydro)siloxane (SiH value determined by gas-volumetric means: 15.6 mol/kg), 1077.51 g of decamethylcyclopentasiloxane (D₅) and 323.32 g of α,ω-dihydropolydimethylsiloxane (SiH value determined by gas-volumetric means: 2.8 mol/kg) were initially charged with stirring into a 2000 ml four-necked flask previously inertized with argon and equipped a precision glass paddle stirrer, an internal thermometer and a reflux condenser on top and then 19.5 g of china clay (1.3% by weight of Speswhite™ based on the overall siloxane mass) and 1.5 g (0.82 ml) of concentrated sulfuric acid (99% by weight) (1000 ppm by weight based on the overall siloxane mass) were applied thereto. The well-stirred reaction mixture is heated to 60° C. for a period of 7 hours, with a target viscosity of 40 mPas already becoming established after 4 hours (sampling).

After 7 hours, 7.5 g of sodium hydrogencarbonate (5000 ppm by weight based on the overall siloxane mass), 0.45 g of deionized water (300 ppm by weight based on the overall siloxane mass) and 19.5 g of filter aid (Harborlite® 900) were added at 60° C. while stirring. The neutralization was allowed to run for a total of 4 hours, before the solid constituents were separated off using a filter press (K 450 filter disc). A droplet of the clear filtrate obtained exhibited a neutral reaction on moist universal indicator paper. A small amount of the filtrate was removed and analysed using ²⁹Si NMR spectroscopy. The spectrum obtained confirms the structure of the hydrosiloxane aimed for above.

1. A process for preparing hydrosiloxanes using acid-modified aluminium silicate as equilibration catalyst, the process comprising:
applying, with mixing, a pulverulent aluminium silicate to a siloxane mixture comprising at least two siloxanes and at least one SiH-functional siloxane, and
preparing the acid-modified aluminium silicate in situ with addition of an acid, thereby forming a reaction mixture, and
allowing the reaction mixture to react with further mixing in a sense of an equilibration.

2. The process according to claim 1, wherein the siloxane mixture comprises at least two different siloxanes that together have methylhydrosiloxy groups, dimethylhydrosiloxy groups and dimethylsiloxy groups.

3. The process according to claim 1, wherein the equilibration is carried out water- and solvent-free.

4. The process according to claim 1, wherein the pulverulent aluminium silicate is pulverulent kaolin.

5. The process according to claim 1, wherein a total amount of the pulverulent aluminium silicate is of 0.3% by weight to 1.5% by weight, based on a total amount of the siloxane mixture.

6. The process according to claim 1, wherein a total amount of the acid is of 30 to 2500 ppm by weight, based on a total amount of the siloxane mixture.

7. The process according to claim 1, wherein the equilibration is carried out in a temperature range of 25° C. to 95° C.

8. The process according to claim 1, wherein the equilibration is carried out within a period of 4 to 12 hours.

9. The process according to claim 1, further comprising:
neutralizing the reaction mixture at the end of the equilibration.

10. The process according to claim 9, further comprising:
separating the neutralized reaction mixture from solids, and
isolating an equilibrated hydrosiloxane.

11. The process according to claim 1, wherein the hydrosiloxanes are unbranched hydrosiloxanes, which have dimethylhydrosiloxy groups, methylhydrosiloxy groups and dimethylsiloxy groups.

12. The process according to claim 1, wherein the hydrosiloxane is an equilibrated hydrosiloxane conforming to the following average structural formula (Formula 1): 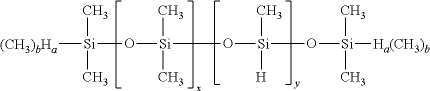
Formula 1,
wherein
$$0 \leq x \leq 200 , \\ 1 \leq y \leq 30 , \\ 0.4 \leq a \leq 1. , \\ 0 \leq b \leq 0.6 , and \\ a + b = 1.$$

13. A hydrosiloxane prepared, by the process according to claim 1.

14. A hydrosilylation process for the preparation of hydrosilylation products, the process comprising:
reacting the hydrosiloxane according to claim 13 as a coreactant.

15. A hydrosilylation product according to claim 14, finding application
(a) as surfactants, dispersing additives, defoamer, wetting aids, hydrophobizing agents and/or crosslinking additives,
(b) in cleaning and/or care formulations suitable for cleaning and/or care of hard surfaces and/or suitable for cleaning, treatment and/or aftertreatment of textiles, and in cosmetic products,
(c) as foam stabilizers or foam additives for polyurethane foams
or
(d) as adjuvants for improving the effect of plant protection active ingredients and/or as carriers for plant protection active ingredients.
